(19) United States
(12) Patent Application Publication
(10) Pub. No.: US 2016/0230803 A1
(43) Pub. Date: Aug. 11, 2016

(54) Snap Hook

(71) Applicant: Chin-Shun Huang, Changhua County (TW)

(72) Inventor: Chin-Shun Huang, Changhua County (TW)

(21) Appl. No.: 14/617,137

(22) Filed: Feb. 9, 2015

(51) Int. Cl. F16B 45/02

(52) U.S. Cl. CPC F16B 45/02

(57) ABSTRACT

A snap hook is equipped with an arched body, a gate, a trigger and a shield. The arched body includes an opening defined between two ends thereof. The gate is pivoted to close and open the opening of the arched body. The trigger is pivoted to lock and release the gate. The shield is used for protecting the trigger.

### BACKGROUND OF INVENTION

1. Field of Invention

The present invention relates to a snap hook and, more particularly, to a reliable snap hook.

2. Related Prior Art

Referring to FIG. 1, a conventional snap hook 100 includes a body 10, a gate 30 and a trigger 40. The body 10 is pivotally connected to both of the gate 30 and the trigger 40. The trigger 40 includes a slot 46. The slot 46 includes a transverse section and a longitudinal section. The terms, “transverse” and “longitudinal”, are given with reference to the trigger 40. The longitudinal section of the slot 46 is much longer than the transverse section. The gate 30 is connected to a pin 29 that extends through the slot 46. The trigger 40 is pivoted between a locking position and a releasing position. In the locking position, the pin 29 is abutted against an edge of the transverse section of the slot 46 to prevent the gate 30 from substantially opening the body 10. In the releasing position, the pin 29 is allowed to move into the longitudinal section of the slot 46 from the transverse section to allow the gate 30 to open the body 10. However, the trigger 40 could easily be pivoted into the releasing position from the locking position by mistake since it is exposed to external objects.

Therefore, the present invention is intended to obviate or at least alleviate the problems encountered in prior art.

### SUMMARY OF INVENTION

It is the primary objective of the present invention to provide a reliable snap hook.

To achieve the foregoing objective, the snap hook includes an arched body, a gate, a trigger and a shield. The arched body includes a first end, a second end, a middle section between the first and second ends, and an opening between the first end and the middle section. The gate includes a first end for abutment against the first end of the arched body and a second end pivotally connected to the arched body. The trigger includes a first end pivotally connected to the middle section of the arched body, a second end opposite to the first end thereof, and a slot near the second end thereof. The pin is movable along the slot and connected to the second end of the gate. The shield includes a rectilinear section extending from the arched body and an arched section extending from the rectilinear section beyond the second end of the trigger.

Other objectives, advantages and features of the present invention will become apparent from the following description referring to the attached drawings.

### BRIEF DESCRIPTION OF DRAWINGS

The present invention will be described via detailed illustration of two embodiments referring to the drawings wherein:

FIG. 1 is a side view of a snap hook according to the first embodiment of the present invention;

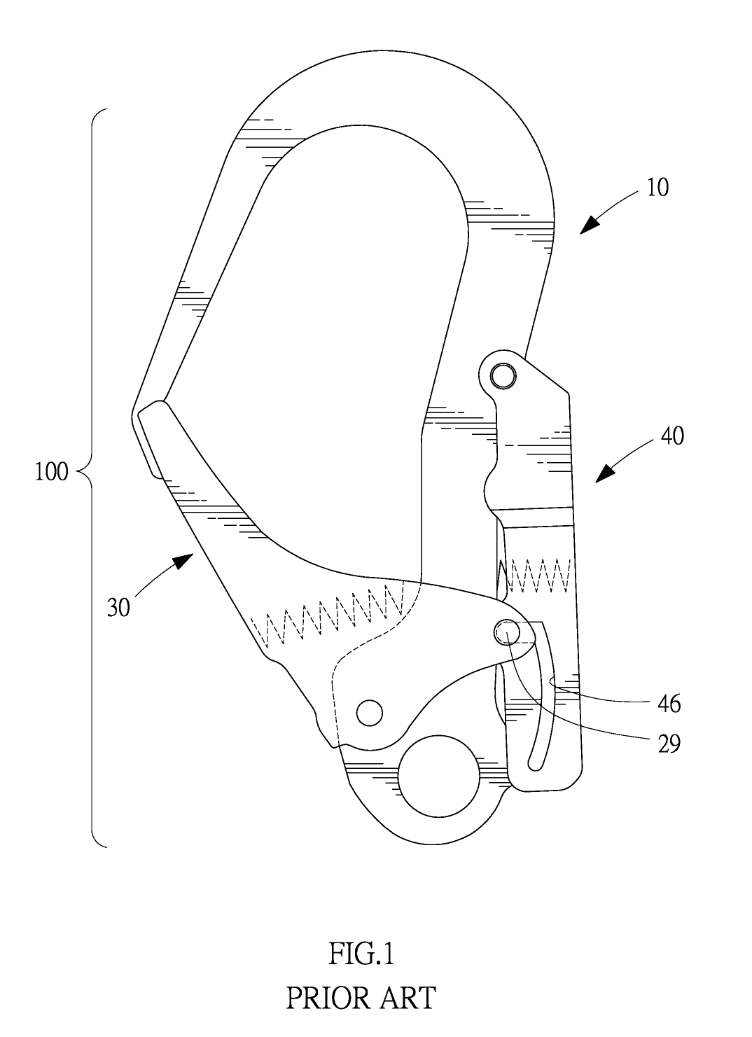

FIG. 2 is a perspective view of the snap hook shown in FIG. 1;

FIG. 3 is a perspective view of a trigger of the snap hook of FIG. 2;

FIG. 4 is a partial side view of the snap hook shown in FIG. 1;

FIG. 5 is a partial side view of the snap hook in another position than shown in FIG. 4; and

FIG. 6 is a perspective view of a snap hook according to the second embodiment of the present invention.

### DETAILED DESCRIPTION OF EMBODIMENTS

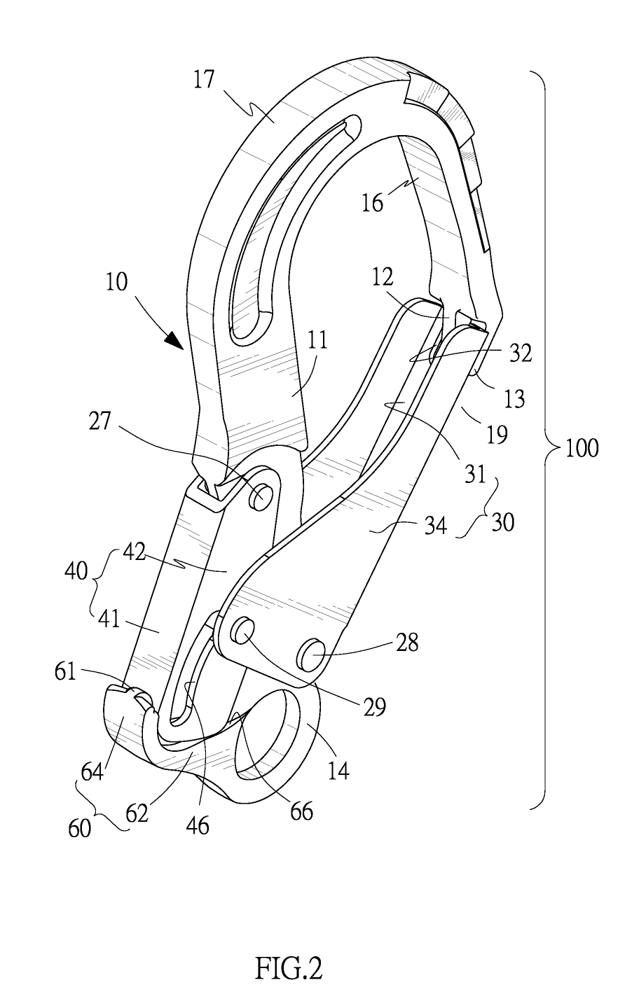

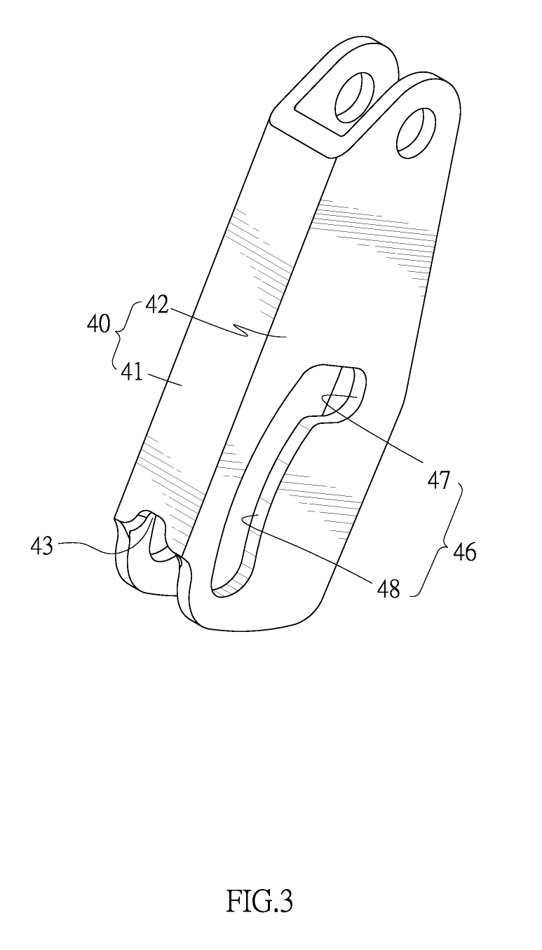

Referring to FIGS. 2 through 5, a reliable snap hook includes an arched body 10, a gate 30 for closing and opening the arched body 10, a trigger 40 for locking and releasing the gate 30, and a shield 60 for protecting the trigger 40 according to a first embodiment of the present invention. The arched body 10 includes a first end 13, a second end 14, a middle section 11 between the first end 13 and the second end 14, and an opening 19 between the first end 13 of the arched body 10 and the middle section 11 of the arched body 10. The arched body 10 further includes an aperture (not numbered) near the second end 14. The arched body 10 further includes an internal edge 16 directed to the opening 19 and an external edge 17 opposite to the internal side 16. The arched body 10 further includes a fin 12 formed on the internal edge 16, in the vicinity of the first end 13 of the arched body 10.

The gate 30 includes a front strip 31 extending between two lateral strips 34 extending parallel to each other. Each lateral strip 34 is in the form of a long triangle. Each lateral strip 34 includes a corner (the “first corner”) far from two other corners (the “second corner” and the “third corner”). The front strip 31 includes a first end located between the first corners of the lateral strips 34 and a second end located between the second corners of the lateral strips 34. A cutout 32 is made in the first end of the front strip 31.

The second corners of the lateral strips 34 are pivotally connected to a portion of the arched body 10 near the second end by a fastener 28 such as a threaded bolt, a pin, a rivet or any other proper element. Thus, the first end of the front strip 31 is located in the vicinity of the first end 13 of the arched body 10.

The trigger 40 includes a back strip 41 extending between lateral strips 42 extending parallel to each other. Each lateral strip 42 is made with an aperture (not numbered) near a first end and a slot 46 near a second end. The slot 46 includes a transverse section 47 and a longitudinal section 48. The terms, “transverse” and “longitudinal”, are given with reference to the trigger 40. The longitudinal section of the slot 46 extends in an arched path. The first ends of the lateral strips 42 extend beyond a first end of the back strip 41 and the second ends of the lateral strips 42 extend beyond a second end of the back strip 41. A cutout 43 is made in the second end of the back strip 41.

The first ends of the lateral strips 42 are pivotally connected to the middle section 11 by a fastener 27 such as a threaded bolt, a pin, a rivet or any other proper element inserted in the apertures made therein. The lateral strips 42 of the trigger 40 are pivotally connected to the lateral strips 34 of the gate 30 by a pin 29 such as a threaded bolt, a pin, a rivet or any other proper element. The pin 29 extends through the slots 46, with two ends inserted in the third corners of the lateral strips 34. Thus, the pin 29 is moved along the slots 46 when the trigger 40 is pivoted relative to the gate 30.

The shield 60 includes a rectilinear section 62 transversely extending from the second end of the arched body 10 and an arched section 64 extending from the rectilinear section 62. The shield 60 further includes a fin 61 extending on and along a centerline of a concave face 66 of the shield 60 that is directed towards the trigger 40. The concave face 66 is shaped in compliance with lower edges of the lateral strips 42.

In use, a section of rope (not shown) is inserted through the aperture near the second end 14 of the arched body 10. The trigger 40 can be pivoted between a locking position and a releasing position.

In the locking position, the pin 29 is abutted against an edge of the transverse section 47 of the slot 46 of each lateral strip 42 to keep the first end of the front strip 31 of the gate 30 against the first end 13 of the arched body 10. Thus, the trigger 40 locks the gate 30 that closes the opening 19. The fin 12 is inserted in the cutout 32 to keep the gate 30 in position laterally relative to the first end 13 of the arched body 10.

In the releasing position, the pin 29 is allowed to move in and along the slot 46 of each lateral strip 42 to allow the first end of the front strip 31 of the gate 30 to move from the first end 13 of the arched body 10. Thus, the trigger 40 releases the gate 30 that can be pivoted to open the opening 19.

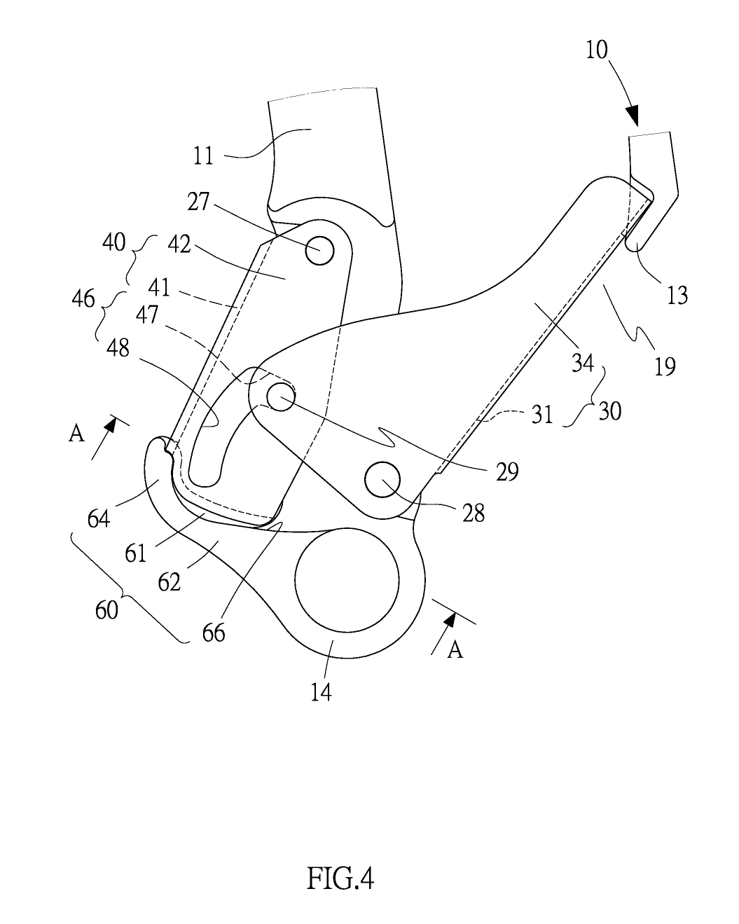

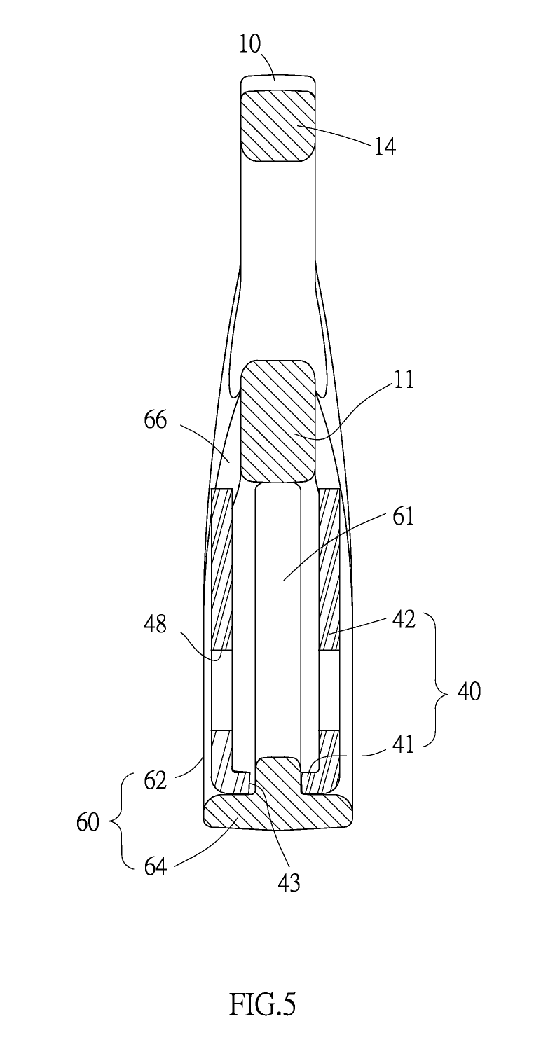

Referring to FIG. 4, the shield 60 extends beyond the trigger 40. In detail, the arched section 64 of the shield 60 is located beyond the second end of the back strip 41 of the trigger 40 and the second ends of the lateral strips 42 of the trigger 40. That is, the lower end of the trigger 40 is located between the arched section 64 of the shield 60 and the arched body 10. Hence, the trigger 40 is protected by the shield 60, and the risk of the trigger 40 pivoted into the releasing position from the locking position by mistake is reduced. Referring to FIG. 5, the fin 61 is inserted in the cutout 43 to keep the trigger 40 in position laterally relative to the shield 60.

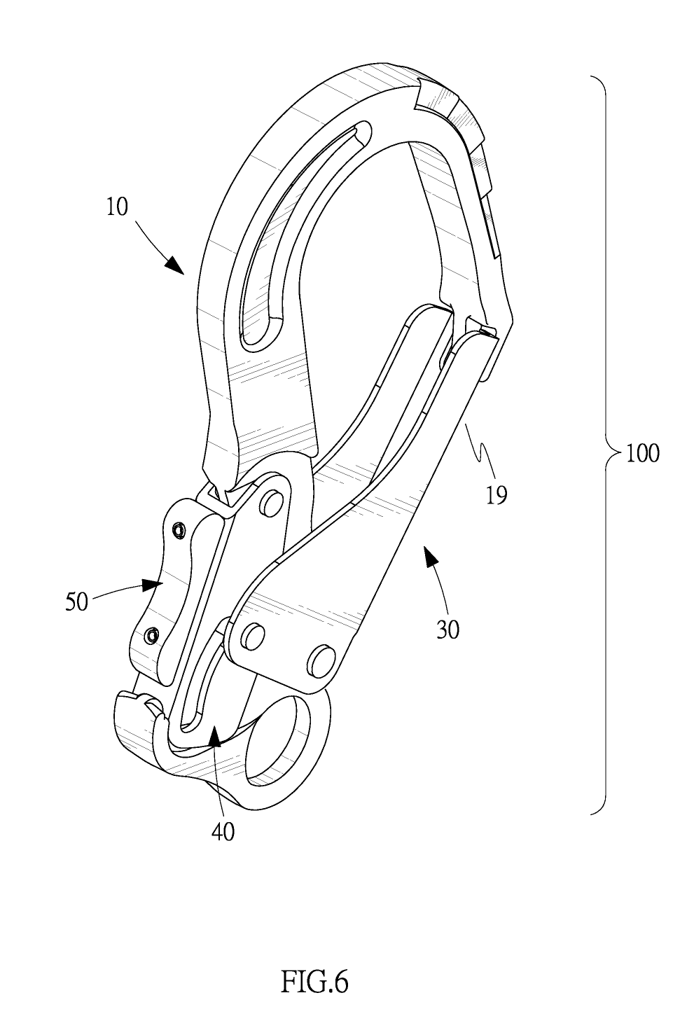

Referring to FIG. 6, there is a snap hook according to a second embodiment of the present invention. The second embodiment is identical to the first embodiment except for including a security device 50 in addition.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A snap hook including:
an arched body including a first end, a second end and a middle section between the first and second ends;
a gate including a first end for abutment against the first end of the arched body and a second end pivotally connected to the arched body;
a trigger including a first end pivotally connected to the middle section of the arched body, a second end opposite to the first end thereof, a back strip extending from the first end thereof to the second end thereof, and a slot near the second end thereof;
a pin inserted in the slot and connected to the second end of the gate, wherein the pin is movable along the slot to allow the gate to pivot to disengage the first end of the gate from the first end of the arched body when the trigger is pivoted by pressing the back strip; and
a shield including a rectilinear section extending from the arched body and an arched section extending from the rectilinear section beyond the second end and the back strip of the trigger to avoid accidental pressing of the back strip of the trigger to avoid accidental pivoting of the trigger to avoid accidental movement of the first end of the gate from the first end of the arched body.

2. The snap hook according to claim 1, wherein the shield includes a fin extending on at least the arched section thereof, wherein the trigger includes a cutout for receiving the fin to keep the trigger in position laterally relative to the shield.

3. The snap hook according to claim 2, wherein the fin further extends on the rectilinear section of the shield.

4. The snap hook according to claim 1, wherein the arched body includes a fin formed near the first end, wherein the gate includes a cutout for receiving the fin to keep the gate in position laterally relative to the arched body.

5. The snap hook according to claim 1, wherein the rectilinear section of the shield extends from the second end of the arched body.

6. The snap hook according to claim 5, wherein the rectilinear section of the shield transversely extends from the second end of the arched body.
